(19) United States
(12) Patent Application Publication
(10) Pub. No.: US 2011/0109407 A1
(43) Pub. Date: May 12, 2011

(54) SIGNAL TRANSMISSION LINE

(75) Inventor: Nobuyuki Horie, Kawasaki-shi (JP)

(73) Assignee: CANON KABUSHIKI KAISHA, Tokyo (JP)

(21) Appl. No.: 12/907,950

(22) Filed: Oct. 19, 2010

(30) Foreign Application Priority Data
Nov. 9, 2009 (JP) 2009-256545

(51) Int. Cl. H01P 3/08

(52) U.S. Cl. 333/238

(57) ABSTRACT

A signal transmission line in which a signal line and a GND, both configured of a conductor foil, are formed within a dielectric, the signal transmission line being influenced by an electrostatic bond in the case where the signal transmission line has been disposed in a housing. In the signal transmission line, the shape of the conductor foil is configured so that a margin from a predetermined mask in an eye pattern in the case where the signal transmission line is disposed in the housing is greater than a margin of a signal transmission line in which the shape of the conductor foil is configured so as to be constant between a transmitting end and a receiving end of the signal transmission line.

### BACKGROUND OF THE INVENTION

1. Field of the Invention

The present invention relates to signal transmission lines connected by flexible cables or the like.

2. Description of the Related Art

FIG. 1A is a cross-sectional view of a signal transmission line having a strip line structure. Meanwhile, FIG. 1B is a cross-sectional view of a signal transmission line having a coplanar structure. Each signal transmission line is formed using a dielectric 101, a conductor foil (signal line) 102, and a conductor foil (GND) 103. The strip line structure is, as shown in FIG. 1A, a structure in which the conductor foil (signal line) 102 is formed in the shape of a line within the dielectric 101, with the conductor foil (GND) 103 formed on the front and back surfaces of the dielectric 101. On the other hand, the coplanar structure is, as shown in FIG. 1B, a structure in which the conductor foil (signal line) 102 and the conductor foil (GND) 103 are formed in the shape of a line within the dielectric 101.

FIGS. 2A and 2B are diagrams illustrating states in which two signal transmission lines of those respective structures are close to each other. FIG. 2A illustrates signal transmission lines having the strip line structure, whereas FIG. 2B illustrates signal transmission lines having the coplanar structure. In FIGS. 2A and 2B, the numeral 111 indicates an electrostatic bond between conductors, whereas the numeral 112 indicates the distance between the signal transmission lines that are close to each other. As shown in FIG. 2A, in the case of a signal transmission line having the strip line structure, the electrostatic bonds 111 of the signal lines 102 are contained within their respective signal transmission lines by the surfaces of the upper and lower conductor foils (GND) 103, and thus have no influence on each other between the two signal transmission lines that are close to each other. However, as shown in FIG. 2B, in the case of a signal transmission line having the coplanar structure, there are no conductor foils (GND) 103 above and below the signal line 102. For this reason, the electrostatic bond 111 is not contained within a single signal transmission line, and the electrostatic bonds of signal lines exert influence upon each other when two such signal transmission lines come close to each other.

The characteristic impedance Zo of a signal transmission line is found through the following formula (1). Here, L expresses the inductance per unit length, whereas C expresses the capacitance per unit length.

Z₀=\sqrt{L/C} (1)

In the case of signal transmission lines having the coplanar structure, if the distance 112 between the signal transmission lines that are close to each other changes, the electrostatic bond (C component) changes due to the change in distance between the conductors, leading to a change in the characteristic impedance of the signal transmission line. In other words, if the signal transmission lines approach each other, the electrostatic bond between the conductors that are close to each other strengthens, and the characteristic impedance decreases. Conversely, if the signal transmission lines move away from each other, the electrostatic bond between the conductors that are close to each other weakens, and the characteristic impedance increases.

In signal transmission, impedance matching between the transmission line and input/output is important; mismatched impedances cause a degradation in the signal waveform in the transmission line, which makes it impossible to carry out highly-reliable communication.

It is difficult to achieve impedance matching in a signal transmission line whose characteristic impedance changes.

Furthermore, signal transmission lines within a device are used in a variety of applications, such as signal transmission in complex housing structures, the mobilization of transmission lines, and so on. For this reason, there is demand for the ability to achieve characteristic impedance matching while at the same time maintaining the flexibility of the transmission lines.

A conventional method has been disclosed in which, to handle changes in the characteristic impedance of a signal transmission line, a cable conductor is disposed in a slanted manner in a transmission line having a wound structure, and as a result, conductors that are close to each other overlap in shifted locations, thus reducing the electrostatic bond between the conductors. For example, see Japanese Patent Laid-Open No. 2005-100708.

There are also techniques for preventing the degradation of the overall transmission characteristics of a network transmission line web in the case where a line connection connector having a different characteristic impedance than the characteristic impedance required for the transmission line is present in the network line web. For example, US-2001-0034142A1 discloses a method in which the width of the transmission line pattern near the connection pins of a line connection connector is progressively changed as the line approaches the connection pins.

However, with the technique disclosed in the aforementioned Japanese Patent Laid-Open No. 2005-100708, extra cable width corresponding to the slanted arrangement of the conductor is necessary, and thus from the standpoint of miniaturization, this technique has been unsuitable when transmitting multiple signals. This technique also cannot be applied in response to characteristic impedance fluctuations in non-wound structures. Furthermore, with the technique disclosed in US-2001-0034142A1, it is impossible to avoid degradation in the signal quality when there is a large difference in the impedances of the two lines.

Finally, neither disclosure mentions taking measures with respect to the problem of partial changes in characteristic impedance caused by the wiring states in the devices illustrated in FIGS. 2A and 2B and described in the related art.

### SUMMARY OF THE INVENTION

The present invention provides a signal transmission line in which the characteristic impedance of the signal transmission line can be corrected at a low cost.

Furthermore, the present invention provides a signal transmission line in which degradation of signal waveforms and the occurrence of noise caused by mismatched impedances is reduced, at a low cost.

Moreover, the present invention provides a signal transmission line in which the characteristic impedance of the signal transmission line can be corrected without sacrificing cable flexibility.

According to one aspect of the present invention, there is provides a signal transmission line in which a signal line and a GND, both configured of a conductor foil, are formed within a dielectric, the signal transmission line being influenced by an electrostatic bond in the case where the signal transmission line has been disposed in a housing, where the shape of the conductor foil is configured so that a margin from a predetermined mask in an eye pattern in the case where the signal transmission line is disposed in the housing is greater than a margin of a signal transmission line in which the shape of the conductor foil is configured so as to be constant between a transmitting end and a receiving end of the signal transmission line.

Further features of the present invention will become apparent from the following description of exemplary embodiments with reference to the attached drawings.

### BRIEF DESCRIPTION OF THE DRAWINGS

FIG. 1A is a cross-sectional view of a signal transmission line having a strip line structure, whereas FIG. 1B is a cross-sectional view of a signal transmission line having a coplanar structure.

FIGS. 2A and 2B are diagrams illustrating states in which two signal transmission lines are close to each other.

FIG. 3A is a diagram illustrating the configuration of a signal transmission line according to an embodiment of the present invention, whereas FIG. 3B is a simplified diagram of the vicinity of a housing.

FIG. 4A is a diagram illustrating the characteristic impedance in a signal transmission line having a fixed line width in a conventional model, whereas FIG. 4B is a diagram illustrating a characteristic impedance that is constant throughout all areas of a signal transmission line.

FIG. 5 is a top view of a signal transmission line having a fixed line width in a conventional model.

FIG. 6 is a diagram illustrating an example of a structure in which partial changes in a characteristic impedance have been effected according to an embodiment of the present invention.

FIG. 7 is a diagram illustrating a microstrip line structure.

FIG. 8 is a diagram illustrating a characteristic impedance when a dielectric thickness H has been changed.

FIG. 9A is a diagram illustrating an eye pattern of a conventional signal transmission line (FIG. 5), whereas FIG. 9B is a diagram illustrating improved eye pattern results obtained when using a signal transmission line according to an embodiment of the present invention.

FIG. 10A is a diagram illustrating a variation, and FIG. 10B is a diagram illustrating another variation.

FIG. 11 is a diagram illustrating a variation.

FIG. 12A is a diagram illustrating the external form of a network camera and a signal transmission line within the device, whereas FIG. 12B is a diagram in which the signal transmission line within the network camera has been divided into five regions.

FIG. 13A is a diagram illustrating characteristic impedances at respective points when a flexible cable having a conventional coplanar structure (FIG. 5) is employed, whereas FIG. 13B is a diagram illustrating a result of improving the characteristic impedance of a signal transmission line according to an embodiment of the present invention.

FIG. 14 is a diagram illustrating an exemplary structure in which partial change of a characteristic impedance has been effected, according to an embodiment of the present invention.

FIG. 15 is a diagram illustrating an exemplary structure of a network camera having pan functionality and tilt functionality.

FIG. 16A is a diagram illustrating a rotational portion rotated to the left central to the axis of an anchoring portion, whereas FIG. 16B is a diagram illustrating the rotational portion rotated to the right.

FIG. 17A is a diagram illustrating fluctuation of characteristic impedance in a tilt rotational portion, whereas FIG. 17B is a diagram illustrating the correction of the characteristic impedance so that the fluctuation thereof is at a minimum relative to a target characteristic impedance value.

FIG. 18 is a diagram illustrating the configuration of a signal transmission line according to an embodiment of the present invention.

### DESCRIPTION OF THE EMBODIMENTS

Embodiments for carrying out the present invention will be described in detail hereinafter with reference to the drawings. First, as a first embodiment according to the present invention, a method for correcting characteristic impedance when housings are close to each other will be described.

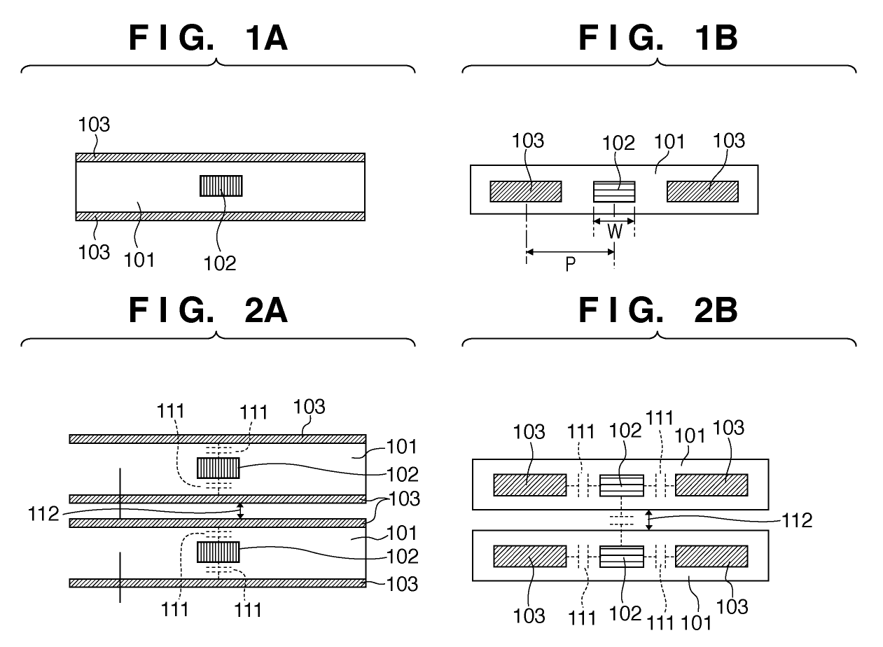

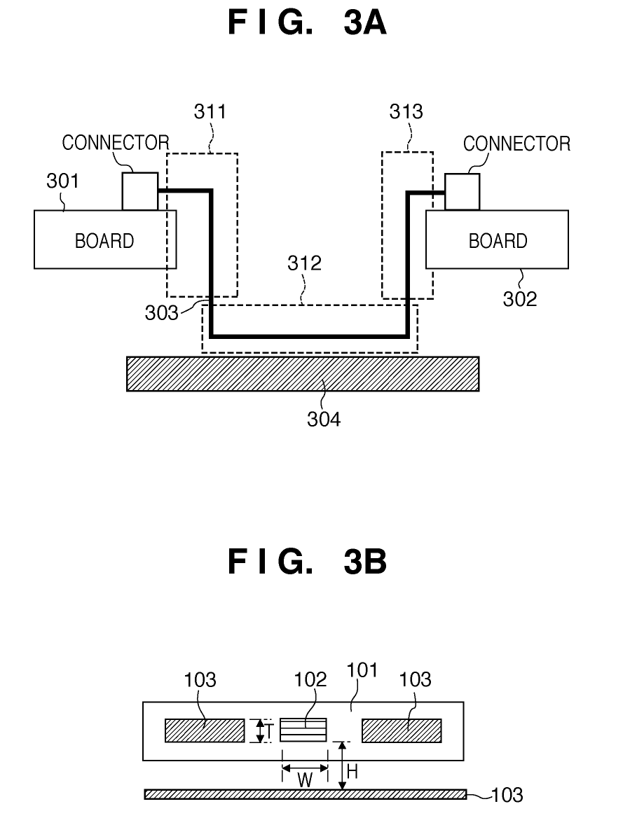

FIG. 3A is a diagram illustrating the configuration of a signal transmission line according to the first embodiment. A board 301 and a board 302 are connected by a signal transmission line 303, thus carrying out the transmission of signals. The signal transmission line 303 is a flexible cable having a coplanar structure, such as that shown in FIG. 1B, that has been incorporated into a housing. A housing (GND) 304 is disposed in the vicinity of the signal transmission line 303. Part of the signal transmission line 303 is close to the housing 304. Of the signal transmission line 303, a region 311 spanning from a connector of the board 301 to the area that is before the area where the line is close to the housing, a region 312 corresponding to the area that is close to the housing, and a region 313 spanning from the area that is after the area where the line is close to the housing to a connector of the board 302 are defined.

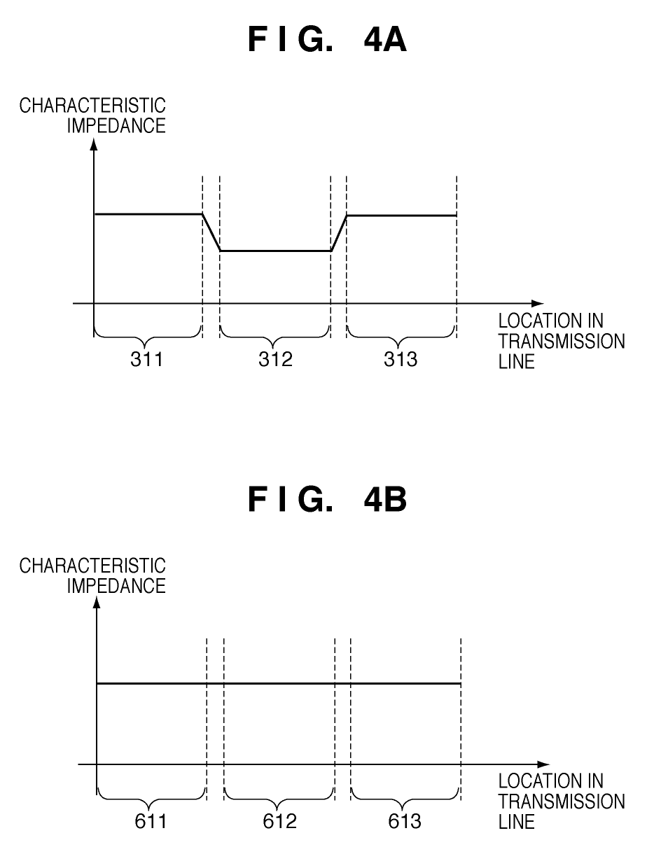

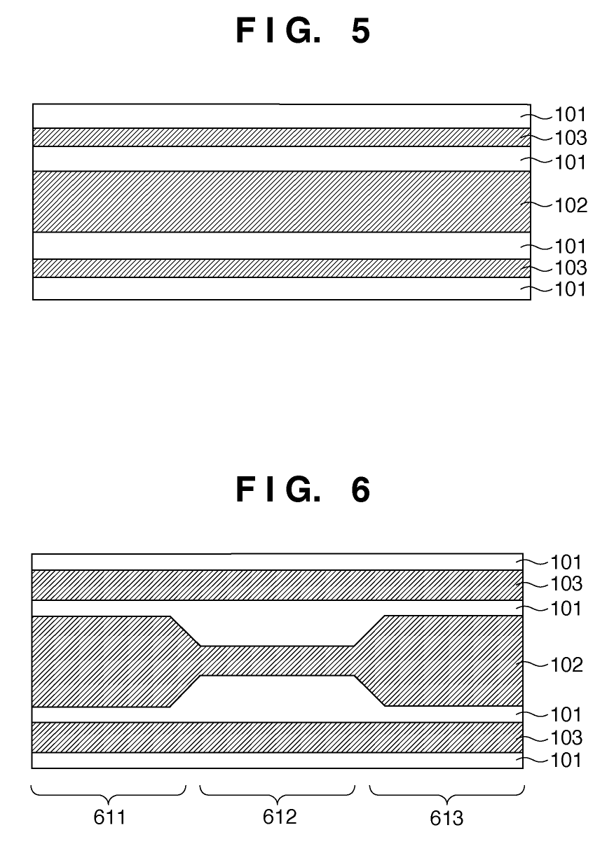

FIG. 4A is a diagram illustrating the characteristic impedance in a signal transmission line having a coplanar structure with a fixed line width in a conventional model as shown in FIG. 5. The characteristic impedance in the regions 311 to 313 shown in FIG. 3A differs depending on the location in the transmission line, as shown in FIG. 4A. The characteristic impedances in the region 311 and the region 313 are almost the same value as the characteristic impedance in free space. This is because there is nothing that influences the characteristic impedance present in the vicinity of the signal transmission line. However, the value of the characteristic impedance drops in the region 312. This is because a GND surface is close to the top, the bottom, or both of the signal line in the signal transmission line 303 and an electrostatic bond has strengthened as a result, causing a fluctuation in the characteristic impedance.

FIG. 6 is a diagram illustrating an exemplary structure in which partial change of the characteristic impedance has been effected, according to the first embodiment. The exemplary structure illustrated in FIG. 6 shows a top view of a flexible cable, and this flexible cable is formed of a dielectric 101, a conductor foil (signal line) 102, and a conductor foil (GND) 103. Here, signal transmission line areas 611 to 613 illustrated in FIG. 6 correspond to the regions 311 to 313 illustrated in FIG. 3A, and the conductor width of the signal line is caused to change therein. In the area close to the housing in the region 312, the electrostatic bond between the conductors that are close to each other strengthens, and thus the characteristic impedance decreases. The amount by which the characteristic impedance decreases is corrected by setting the characteristic impedance to be higher in advance. In other words, reducing the width of the signal line in the signal transmission line area 612 illustrated in FIG. 6 makes the correction. With respect to the signal transmission line areas 611 and 613, it should be noted that because the characteristic impedance is almost the same as the characteristic impedance in free space, the widths of the wires in the flexible cable are not changed.

Due to the structure illustrated in FIG. 6, the characteristic impedance in the signal transmission line areas 611 to 613 is constant in all areas of the signal transmission line, as shown in FIG. 4B. In other words, the fluctuation in the characteristic impedance in the region 312 in the area that is close to the housing decreases relative to the characteristic impedance when using a conventional signal transmission line (FIG. 4A), resulting in a constant characteristic impedance in the signal transmission line. Here, the characteristic impedance is made constant. However, if the signal line width is reduced so that the decrease in characteristic impedance caused by the electrostatic bond in the case where the line is disposed within a housing is 50% or more, signal degradation caused by mismatched impedances can be sufficiently reduced.

Next, specific calculation formulas regarding the correction will be described. First, the characteristic impedance of a flat cable having a coplanar structure is normally found through the following formula (2). εₑ expresses an effective relative dielectric constant, εᵣ expresses a relative dielectric constant of the medium, and V expresses an air ratio of the medium. P expresses the pitch between conductor centers, and d expresses the outer form of a round-shaped conductor (the radius of the corresponding circle is employed when the conductor is a flat type). Finally, cosh⁻¹ expresses a hyperbolic arc cosine function.

$$\begin{matrix}{Z}_{0} = \frac{42}{\sqrt{{ɛ}_{e}}} {cosh}^{- 1} \{ 1.8 {( \frac{P}{d} )}^{2} - \sqrt{1.25 {( \frac{P}{d} )}^{2} - 1} \} & ( 2 ) \\ \sqrt{{ɛ}_{e}} = \sqrt{{ɛ}_{r}} ( 1 - \frac{V}{100} ) + \frac{V}{100} & ( 3 )\end{matrix}$$

As shown in the above formula (2), if the dielectric and the conductor outer form are set, a characteristic impedance Zo is determined by the interconductor pitch P. Meanwhile, conversely speaking, if the interconductor pitch P has changed, the characteristic impedance can be corrected by changing the conductor outer form d.

Conventionally, the characteristic impedance of a single signal transmission line has been determined only by the cable structure thereof. However, under such circumstances, when the signal transmission line is incorporated into a housing (GND), the characteristic impedance thereof experiences increased fluctuations.

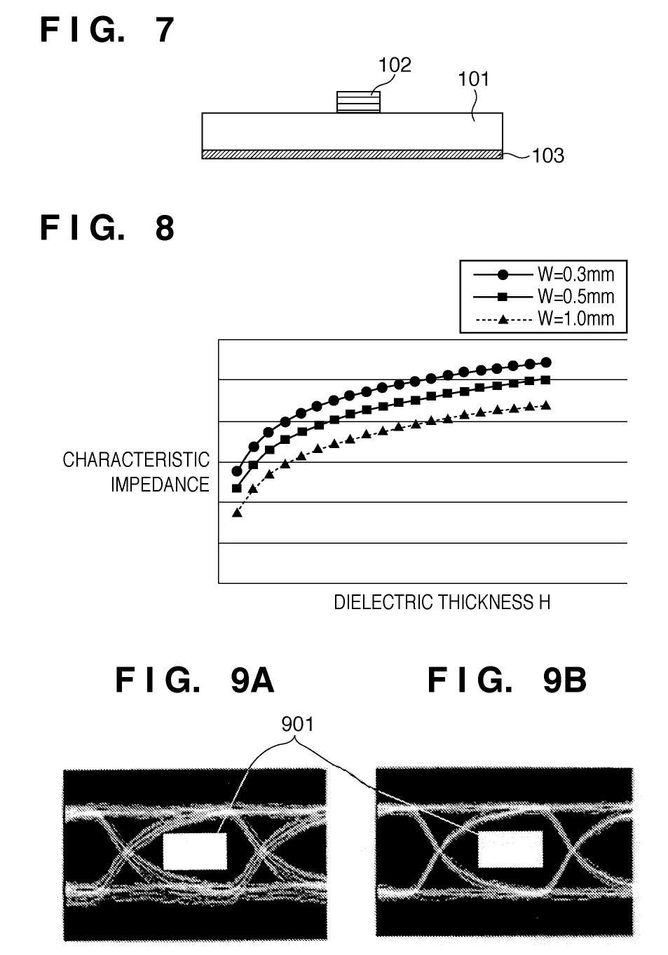

The characteristic impedance when a housing (GND) has come close to the signal transmission line can be calculated to an approximate value by handling the signal transmission line as having a pseudo-microstrip line structure. As shown in FIG. 7, the microstrip line structure has a structure in which a line-shaped conductor 102 has been formed upon the front surface of the dielectric 101, on the back surface of which has been formed a conductor (GND) 103. Meanwhile, this structure corresponds to a structure in which the conductor (GND) 103 on the front surface has been removed from the internal conductor in a strip line structure, such as that illustrated in FIG. 3B.

FIG. 3B is a simplified diagram of the vicinity of a housing, through which it can be seen that a housing surface (GND) has come close to the vicinity of the signal transmission line having a coplanar structure. Despite the signal transmission line having a coplanar structure, the characteristic impedance of this signal transmission line is, for the region 312 in the vicinity of the housing, calculated as the characteristic impedance of a microstrip line. The formula for calculating the characteristic impedance as a microstrip line is indicated in the following formula (4). Here, H expresses a dielectric thickness, T expresses a conductor thickness, and W expresses a conductor width. In is a binary logarithm.

$${Z}_{0} = \frac{87}{\sqrt{{ɛ}_{r} + 1.41}} ln \{ \frac{5.98 H}{0.8 W + T} \} \qquad ( 4 )$$

As shown in the above formula (4), the characteristic impedance changes in accordance with the thickness H of the dielectric. In other words, the characteristic impedance rises as the thickness of the dielectric increases. Meanwhile, the characteristic impedance curves differ depending on the conductor width. The characteristic impedance drops as the conductor width increases, whereas the characteristic impedance rises as the conductor width decreases.

FIG. 8 is a diagram illustrating the characteristic impedance when the dielectric thickness H in the above formula (4) has been changed. The X axis represents the thickness of the dielectric, whereas the Y axis represents the characteristic impedance. The conductor width W is taken as 0.3 mm, 0.5 mm, and 1.0 mm, whereas the conductor thickness T is taken as a fixed value. From FIG. 8, it can be seen that the characteristic impedance drops as the dielectric thickness H decreases (that is, as the housing comes close). Accordingly, in the first embodiment, the conductor width W is reduced and correction is carried out in order to prevent a drop in the characteristic impedance at the areas in which the distance to the close housing (GND) is low.

Because the characteristic impedance does not fluctuate and is stable in the regions 311 and 313 indicated in FIG. 3A, the characteristic impedance is determined as the conventional coplanar structure. As opposed to this, in the region 312, the characteristic impedance is determined through approximation as a microstrip, rather than a coplanar structure. In other words, the characteristic impedance is determined taking into consideration the amount of fluctuation when the line is incorporated into the housing so that the characteristic impedance is stable when the line is incorporated into the housing. Through this, it is possible to reduce fluctuations in the characteristic impedance and suppress degradation in the transmitted signal, which in turn makes it possible to transmit high-speed signals in a stable manner.

FIG. 9B is a diagram illustrating improved eye pattern results obtained when using a signal transmission line according to the first embodiment. FIG. 9A illustrates an eye pattern of a conventional signal transmission line (FIG. 5). The board 301 indicated in FIG. 3A serves as the transmitting end, and the signal passes through the signal transmission line 303, with the board 302 serving as the receiving end. FIGS. 9A and 9B are diagrams illustrating eye patterns at the receiving end. Note that although eye patterns are also sometimes referred to as eye diagrams, the following descriptions will use the term “eye pattern”.

An eye pattern graphically represents the characteristics of a signal by superimposing multiple actual signal samples. A waveform can be called a high-quality waveform when the waveform overlaps in multiple identical locations (timing, voltage), whereas a waveform can be called a low-quality waveform when locations in the waveform (timing, voltage) are skewed. The rectangle indicated in FIGS. 9A and 9B is a specified mask 901. In the case where a single waveform has made contact with or passed the mask 901, there is the possibility that the information of the signal transitions will not be properly communicated. Normally, in eye pattern evaluation, the signal quality is judged using the mask 901 as a threshold. As one example, the waveform quality is considered acceptable if the signal waveform does not enter into the mask 901, whereas the waveform quality is considered unacceptable in the case where the signal waveform passes into the mask 901. As shown in FIGS. 9A and 9B, with the first embodiment, it is possible to ameliorate the degradation of transmitted signals. Incidentally, with the first embodiment, the mask 901 is indicated as being a rectangle, but because the specified mask is determined in accordance with the IC capabilities of the receiving end, the mask 901 is not limited to a rectangular shape.

In this manner, the degradation of signals in the signal transmission line can be suppressed by reducing fluctuations in the characteristic impedance, thus making it possible to stabilize the waveform. In addition, a margin from the specified mask 901 in the eye pattern can be increased.

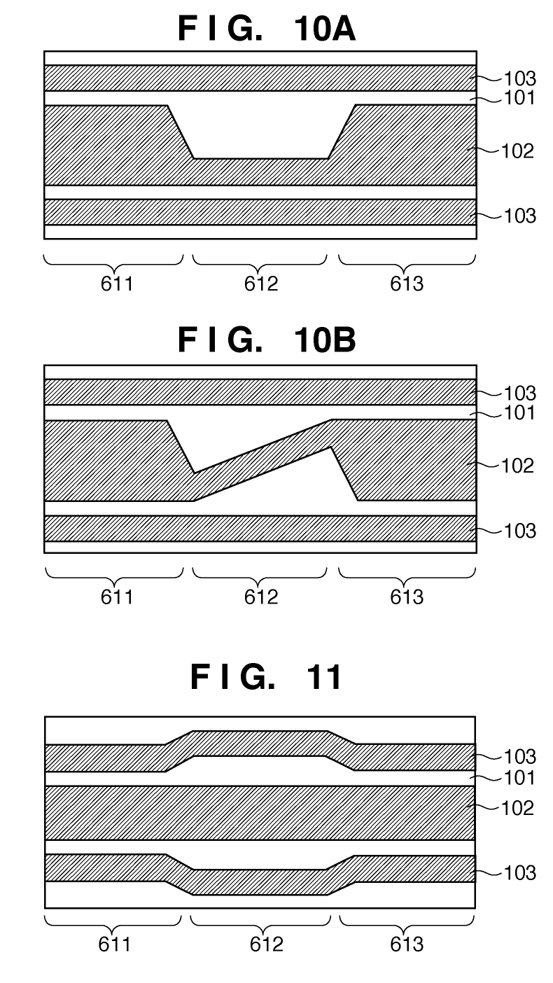

In the case where controlling the line width is employed as the aforementioned method for correcting the characteristic impedance, the line width is determined from the central area of the conductor 102 in the example shown in FIG. 6; however, in addition to narrowing the line width at the central portion in this manner, shapes such as those shown in FIGS. 10A and 10B can also be employed. FIG. 10A illustrates a Variation 1 on the first embodiment. Like FIG. 6, FIG. 10A is a top view of a flexible cable, and the conductor 102 is disposed on the lower side in the signal transmission line area 612. Note that the conductor 102 can also be disposed on the upper side. FIG. 10B illustrates a Variation 2 on the first embodiment. Like FIG. 6, FIG. 10B is a top view of a flexible cable, and the conductor 102 is disposed so as to be sloped from the lower side toward the upper side in the signal transmission line area 612.

In the above descriptions, the conductor width is changed in a signal transmission line configured of a flat wiring member in order to change the characteristic impedance by changing the shape of the conductor foil. In this manner, the same effects can be achieved even if the conductor 102 is not disposed in the center when controlling the line width. However, because the characteristic impedance also changes due to the distance between conductors, it is necessary to change the width between the conductors to a width that is suitable thereto. This is because the characteristic impedance is determined by the ratio between the conductor outer form d and the pitch between conductor centers P.

In addition, the method for correcting the characteristic impedance is not limited to the aforementioned method, and the same effects can be achieved by changing the dielectric thicknesses, conductor thicknesses, intervals between signal lines, and disposition of the GND surfaces in the signal transmission line on a region-by-region basis.

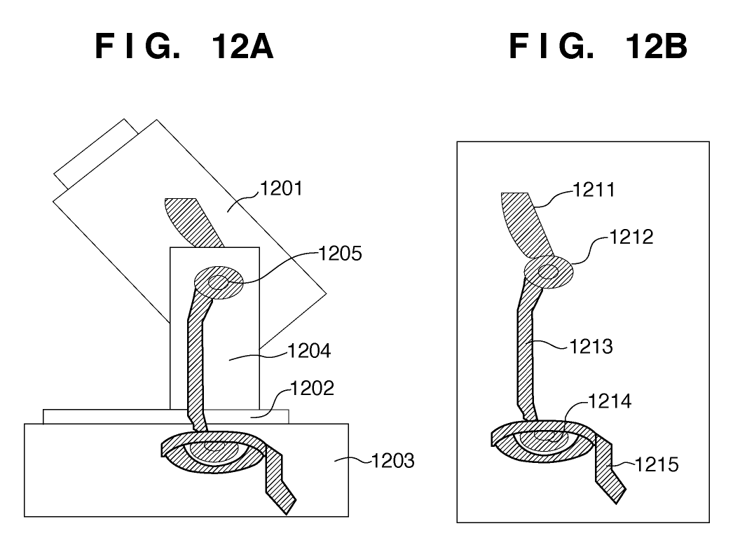

A specific example of a change aside from the conductor width will be discussed hereinafter. FIG. 11 illustrates a Variation 3 on the first embodiment. In other words, the interval between the conductors is changed in a signal transmission line configured of a flat wiring member in order to change the characteristic impedance by changing the shape of the conductor foil. This makes it possible to correct the characteristic impedance by changing the distance from a signal line rather than changing the width of the signal line.

According to the first embodiment, fluctuations in the characteristic impedance of the signal transmission line can be suppressed, and it is thus possible to suppress degradation in transmitted signals and transmit the signals in a stable manner.

Next, a second embodiment according to the present invention will be described in detail with reference to the drawings. The second embodiment describes correction of the characteristic impedance of a mobile signal transmission line.

FIGS. 12A and 12B are diagrams illustrating the configuration of an internal signal transmission line in a network camera that transmits signals between a camera head and a bottom case, and whose camera head has functionality for rotating in the horizontal direction (pan) and the vertical direction (tilt). FIG. 12A is a diagram illustrating the external form of the network camera and the signal transmission line within the device. FIG. 12B, meanwhile, is a diagram in which the signal transmission line within the network camera has been divided into five regions. In addition, the signal transmission line is a line in which a flexible material such as an FFC (flexible flat cable), an FPC (flexible printed circuit), or the like has been incorporated into a housing.

As illustrated in FIG. 12A, the network camera is configured of a camera head 1201, a turntable 1202, a bottom case 1203, a support column 1204, and a vertical direction rotational shaft 1205. The camera head 1201, which includes an imaging system, rotates in the vertical direction central to the rotational shaft 1205 in the support column 1204. The support column 1204 is anchored to the turntable 1202. The structure is such that the bottom case 1203 and the turntable 1202 are separated, and the turntable 1202, the support column 1204, and the camera head 1201 rotate in the horizontal direction.

Meanwhile, contact points for signals, power source transmission lines, and so on are present in the bottom case 1203. Electric circuits in the camera head 1201 and the bottom case 1203 are connected by the signal transmission line. An image signal captured by the camera head 1201 is transmitted to a board (not shown) within the bottom case 1203 via the signal transmission line.

As shown in FIG. 12B, the signal transmission line is a single signal transmission line that transmits image signals from the camera head 1201, which serves as a rotational portion, to the board (not shown) within the bottom case 1203. For the sake of simplicity, the signal transmission line is divided into five regions 1211 to 1215, which will be described hereinafter. A first region 1211 is a region extending from the camera head 1201 to the rotational shaft of the support column 1204. A second region 1212 serves as a rotational portion rotating in the vertical direction (a tilt rotational portion). A third region 1213 serves as a portion close to the support column 1204. A fourth region 1214 serves as a rotational portion rotating in the horizontal direction (a pan rotational portion). Finally, a fifth region 1215 serves as a region within the bottom case 1203.

Because the camera head 1201 and the turntable 1202 rotate at the tilt rotational portion and the pan rotational portion, the signal transmission line that connects the rotational portion with an anchoring portion is wrapped around the rotational shaft several times, thus absorbing movement during rotation. Meanwhile, because the signal transmission line is wrapped around the rotational shaft several times at the tilt rotational portion in the second region 1212 and the pan rotational portion in the fourth region 1214, the distance between signal transmission lines is no greater than a certain value, and thus the characteristic impedance is affected by electrostatic bonds between the signal transmission lines. Furthermore, because the third region 1213 is disposed close to the support column 1204, the characteristic impedance fluctuates under the influence of the support column 1204. Because there are no conductive bodies in the vicinity of the signal transmission line in the first region 1211 and the fifth region 1215, the characteristic impedance has almost the same value as the characteristic impedance in free space.

Conventionally, when transmitting signals of a VGA (640×480 dots) image in parallel, fluctuations in the characteristic impedance in the tilt rotational portion in the second region 1212, the pan rotational portion in the fourth region 1214, and the area close to the housing in the third region 1213 do not pose a major problem. This is because the influence of electrostatic bonds arising when the signal transmission line comes close to the housing or sections of the signal transmission lines come close to each other is not dominating in the frequency that is required for the transmission of VGA image signals (up to several tens of MHz). However, in the transmission of image signals having a large number of pixels, such as SXGA (1280×1024 dots), HD (1920×1080 dots), or the like, or when multiplexing VGA image signals and transmitting those signals, the signal transmission frequency exceeds 100 MHz, and the influence of electrostatic bonds poses a major problem.

Z₀=\sqrt{(R+jωk)/(G+jωC)} (5)

The above formula (5) is a formula that incorporates signal transmission line loss into the formula (1) for finding the characteristic impedance of a signal transmission line presented in the descriptions of the related art. Here, ω=2πf. In the case where a frequency f for transmitting image signals is in a low frequency band that is no greater than several tens of MHz, the above formula (5) indicates that resistances R and G are more dominant in determining the characteristic impedance value than an electrostatic bond C and an inductance L. However, with the characteristic impedance, the electrostatic bond C and the inductance L become dominant elements as the frequency f increases. For this reason, fluctuations in the characteristic impedance caused by changes in electrostatic bonds, which have thus far not been problematic in high-frequency signal transmission, become great. A large fluctuation in the characteristic impedance negatively influences the signal quality, thus increasing the risk of transmission errors and the like. Although not particularly mentioned outright hereinafter, the present invention relates to the improvement of a signal transmission line when carrying out such high-speed signal transmission.

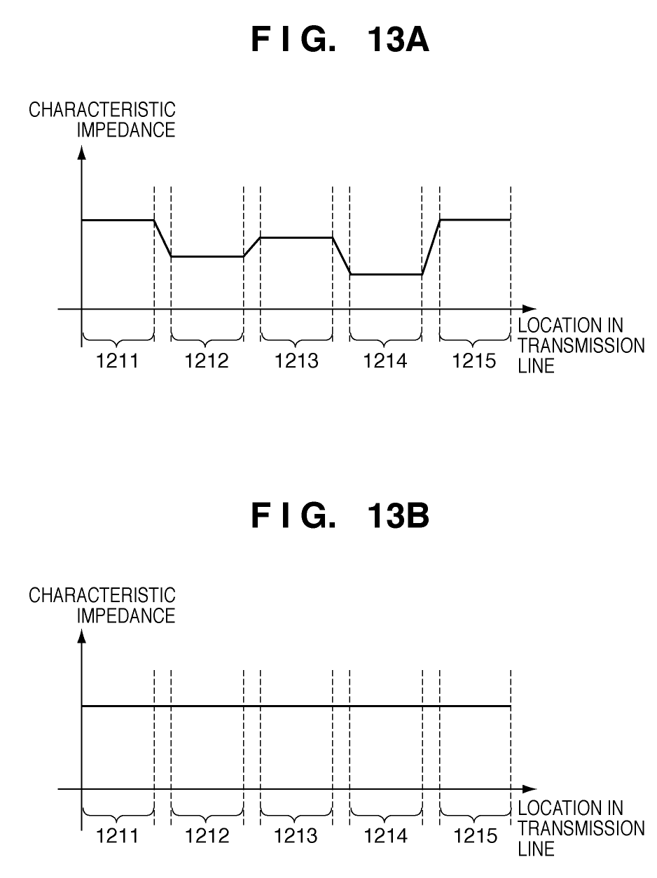

FIG. 13A is a diagram illustrating characteristic impedances at respective points when a flexible cable having a conventional coplanar structure (FIG. 5) is employed. As shown in FIG. 13A, the characteristic impedance fluctuates from region to region in the five regions 1211 to 1215 illustrated in FIG. 12B as a result of the influence of the line being incorporated into a housing. The degree of the fluctuation also differs from region to region.

FIG. 14 is a diagram illustrating an exemplary structure in which partial change of the characteristic impedance has been effected, according to the second embodiment. Like the illustrations in FIG. 6 described in the first embodiment, this exemplary structure is a top view of a flexible cable, and the flexible cable is formed of a dielectric 101, a conductor foil (signal line) 102, and a conductor foil (GND) 103. In addition, in the pan and tilt rotational portions, the signal transmission line is wrapped around a rotational shaft several times in order to absorb movement during rotation. For this reason, the signal transmission line is stacked upon itself in the rotational portions. With respect to a tilt rotational portion 1402 in the second region 1212, the conductors approach each other due to the signal transmission line being stacked upon itself, and as a result, the electrostatic bond between the conductors that have come close to each other strengthens and the characteristic impedance drops. The amount by which the characteristic impedance drops is corrected by setting the characteristic impedance to a high value in advance. In other words, the characteristic impedance is corrected by reducing the signal line width in the signal transmission line. The same applies to a pan rotational portion 1404 in the fourth region 1214.

Here, because the distance between the signal transmission lines differs in the pan rotational portion 1404 and the tilt rotational portion 1402, the characteristic impedance has a different value in those respective portions. Accordingly, different correction values for the characteristic impedance are used in the pan rotational portion 1404 and the tilt rotational portion 1402. In addition, with respect to an area 1403 close to the housing in the third region 1213, the characteristic impedance drops due to the line being close to the surface of the housing, and thus that drop is corrected as well. Furthermore, with respect to areas 1401 and 1405 in the first region 1211 and the fifth region 1215, the characteristic impedance is almost the same as that in free space, and thus the line width of the flexible cable is not changed. Note that a specific formula for calculating the correction values is the same as that described in the method of the first embodiment.

FIG. 13B is a diagram illustrating a result of improving the characteristic impedance of a signal transmission line according to the second embodiment. As shown in FIG. 13B, fluctuations in the characteristic impedance in the second region 1212, the third region 1213, and the fourth region 1214 are, by using a signal transmission line as illustrated in FIG. 14, reduced more than in the case where a conventional signal transmission line is used. Accordingly, if the signal line width is reduced so that the change in characteristic impedance caused by the electrostatic bond in the case where the line is disposed within a housing involves a decrease of 50% or more, signal degradation caused by mismatched impedances can be sufficiently reduced.

In this manner, suppressing fluctuations in the characteristic impedance by changing the conductor widths in regions in which a signal transmission line having a coplanar structure is close to conductive bodies in its periphery makes it possible to suppress degradation in signals in the signal transmission line and transmit high-speed signals in a stable manner.

In addition, in the case where the signal transmission line is mobile, the characteristic impedance differs depending on distance conditions. FIG. 15 is a diagram illustrating an exemplary structure of a network camera having pan functionality and tilt functionality. FIG. 15 illustrates a case where a camera head has been rotated in the horizontal direction to positions corresponding to a right rearward angle 1502 and a left rearward angle 1503 from a position corresponding to a forward direction 1501. FIG. 15 also illustrates a case where the camera head has been rotated in the vertical direction central to a vertical direction rotational shaft to positions corresponding to an upward direction 1512 and a rearward direction 1513 from a position corresponding to a forward direction 1511. In other words, the camera head, which contains an imaging system, has tilt functionality for rotating in the vertical direction central to the rotational shaft 1205 in the support column 1204. The camera head also has pan functionality, where the structure is such that the bottom case 1203 and the turntable 1202 are separated, and the turntable 1202, the support column 1204, and the camera head rotate in the horizontal direction.

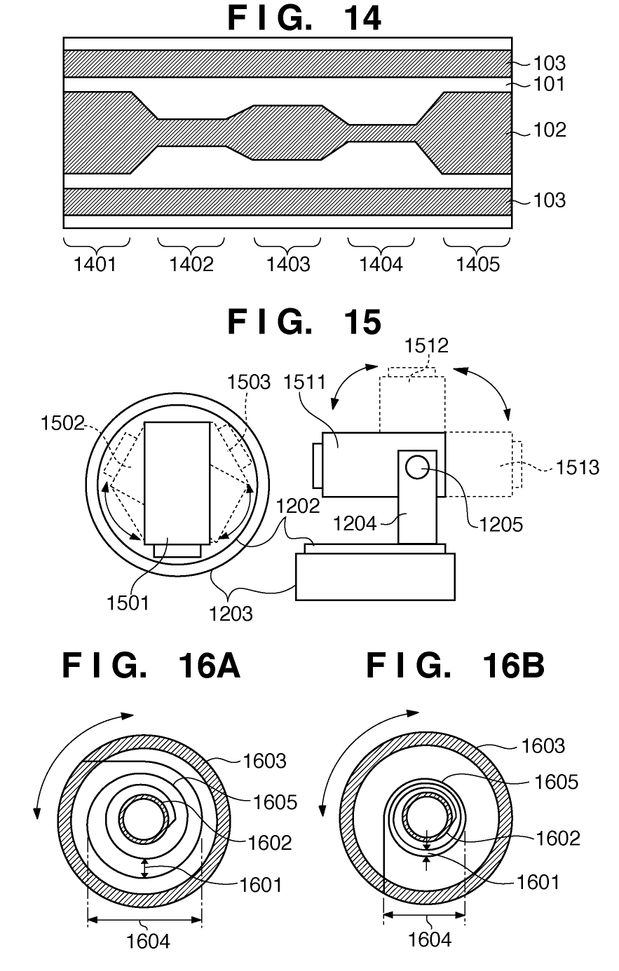

FIGS. 16A and 16B are diagrams illustrating exemplary structures of a signal transmission line that connects a rotational portion to an anchoring portion in a network camera. This example is a cross-sectional view cut along a plane perpendicular to the rotational shaft. FIG. 16A illustrates a state in which a rotational portion 1603 has been rotated left central to an anchoring portion 1602 (that is, in the counterclockwise direction), whereas FIG. 16B illustrates a state in which reverse rotation has been carried out to the right (the clockwise direction).

A signal transmission line 1605 connects the rotational portion 1603 and the anchoring portion 1602 using a flexible material such as an FFC, an FPC, or the like, and is held in a state in which the signal transmission line 1605 is wound central to the anchoring portion 1602. As shown in FIG. 16A, in the case where the rotational portion 1603 has been rotated to the left, the signal transmission line 1605 unwinds, whereas as shown in FIG. 16B, when the rotational portion 1603 has been rotated to the right, the signal transmission line 1605 is wound more tightly. In this manner, the connection between the rotational portion and the anchoring portion is made possible by employing a structure in which the winding state (tightly wound/loosely wound) changes depending on the rotational angle.

However, the change in the winding state (tightly wound/loosely wound) causes changes in a distance 1601 between sections of the signal transmission line that are close to each other and the diameter 1604 of the signal transmission line. If the distance between sections of the signal transmission line changes, a change in the electrostatic bond between conductors that are close to each other will occur as described earlier, leading to a change in the characteristic impedance of the signal transmission line.

In the case where signal transmission is carried out using such a signal transmission line, the characteristic impedance changes due to changes in the winding state; as a result, impedance matching cannot be achieved, signal waveforms degrade in the signal transmission line, and highly-reliable communication cannot be carried out.

Here, characteristic impedance fluctuations in a mobile portion will be described using a tilt rotational portion 1402 as an example. The same applies to a pan rotational portion 1404 as the tilt rotational portion 1402, and thus descriptions thereof will be omitted.

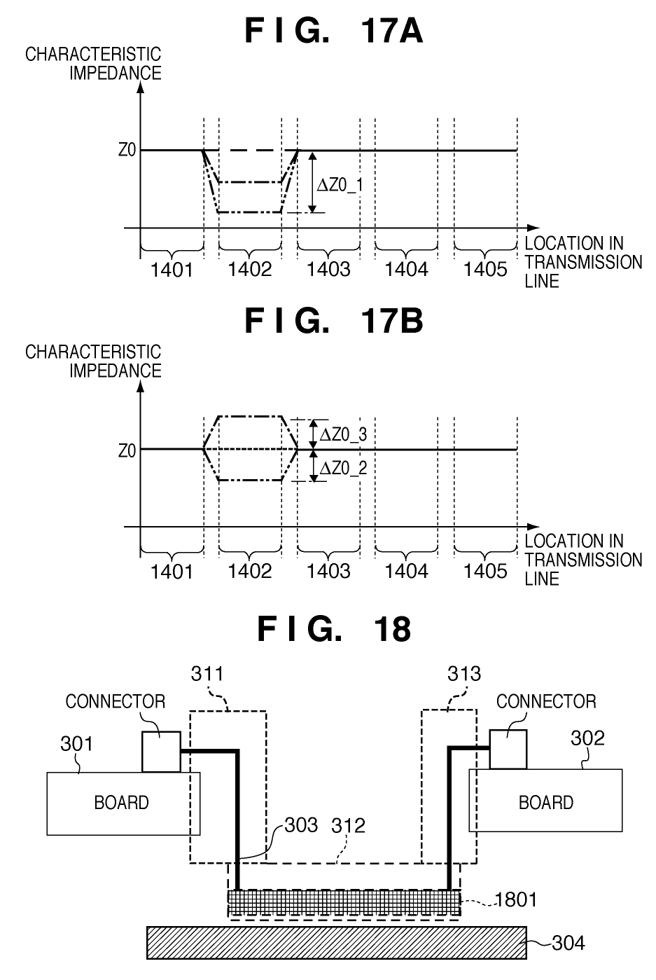

FIG. 17A is a diagram illustrating fluctuations in the characteristic impedance in a tilt rotational portion. The characteristic impedance in the tilt rotational portion 1402 differs between the conditions in which the distance between sections of the signal transmission line is minimum (FIG. 16B) and the conditions in which the distance is maximum (FIG. 16A). The characteristic impedance under the conditions in which the distance is the minimum is indicated by a double-dot-dash line, whereas the characteristic impedance under the conditions in which the distance is the maximum is indicated by a single-dot-dash line. Meanwhile, ΔZ0_1 expresses the amount of skew of the characteristic impedance relative to a target characteristic impedance. Here, the fluctuation of the characteristic impedance under the conditions in which the distance is minimum is ΔZ0_1. Note that the characteristic impedance in the pan rotational portion 1404 is the same as the characteristic impedance in the tilt rotational portion 1402, and is thus not shown.

As shown in FIG. 17A, the characteristic impedance decreases as the distance between sections of the signal transmission line decreases. This is because the electrostatic bond (C component) strengthens as the distance between conductors decreases, thus influencing the characteristic impedance of the signal transmission line. Conversely, as the distance increases, the characteristic impedance approaches the value of the characteristic impedance found in free space. This is because the electrostatic bond (C component) weakens as the distance between conductors increases.

Accordingly, in a signal transmission line in which the characteristic impedance fluctuates due to the conditions of the distance between sections of the signal transmission line, the value of the characteristic impedance is corrected so as to approach a target value, which is the average value of the conditions under which the distance is minimum and the conditions under which the distance is maximum. The characteristic impedance is set so that the fluctuations thereof are at a minimum relative to the target value of the characteristic impedance. In other words, the characteristic impedance is set as shown in FIG. 17B. In FIG. 17B, the characteristic impedance under the conditions in which the distance is the minimum is indicated by a double-dot-dash line, whereas the characteristic impedance under the conditions in which the distance is the maximum is indicated by a single-dot-dash line. Meanwhile, ΔZ0_2 expresses the amount of skew of the characteristic impedance under the conditions in which the tilt rotational portion 1402 is rotated to a maximum relative to a target characteristic impedance value. Furthermore, ΔZ0_3 expresses the amount of skew of the characteristic impedance under the conditions in which the tilt rotational portion 1402 is rotated to a minimum relative to the target characteristic impedance value.

Here, the rate of change in the characteristic impedance can be expressed as follows:

Conventional example: ΔZ0_1/Z0

Present embodiment: ΔZ0_2/Z0 or ΔZ0_3/Z0

Note that Z0 expresses the target characteristic impedance value. When the rate of change of the characteristic impedance is compared with the conventional example, there are less fluctuations from the target value in the present embodiment. This is because ΔZ0_1>(ΔZ0_2 or ΔZ0_3).

In this manner, by reducing fluctuations from the target characteristic impedance value, it is possible to reduce the degradation of transmitted signals and transmit signals in a stable manner even with a signal transmission line having a mobile structure. Accordingly, using such a signal transmission line makes it possible to increase a margin from a specified mask in an eye pattern.

Next, a third embodiment according to the present invention will be described in detail with reference to the drawings. The third embodiment describes a method in which the characteristic impedance is corrected through the partial winding of the dielectric (a sheet).

FIG. 18 is a diagram illustrating the configuration of a signal transmission line according to the third embodiment. In the third embodiment, using the configuration illustrated in FIG. 3A and described in the first embodiment, a dielectric sheet 1801 is wrapped around the region 312 in the area close to the housing in the signal transmission line.

As described in the first embodiment, in the case where a conventional flexible cable having a coplanar structure is employed as the signal transmission line, the characteristic impedance fluctuates in the region 312 in the area close to the housing. In the first embodiment, the characteristic impedance is corrected by changing the line width on a partial basis. However, in the third embodiment, rather than changing the line width, the characteristic impedance is corrected by winding the dielectric sheet 1801.

A change in the characteristic impedance occurs in locations where a dielectric having a different dielectric constant than the air is wrapped around the outer surface of the signal transmission line. This is because, as shown in the formula (4), decreasing the dielectric constant ε causes a rise in the characteristic impedance. Meanwhile, the characteristic impedance rises even if the dielectric thickness H is increased. Accordingly, the characteristic impedance is corrected on a partial basis by wrapping the dielectric sheet 1801 around the region 312 of the signal transmission line in which the characteristic impedance changes and changing the dielectric constant and thickness of the dielectric.

In other words, in the third embodiment, the thickness of the dielectric in the periphery of the conductor or the dielectric constant of the dielectric in the periphery of the conductor is changed. If the dielectric constant and thickness are changed so that the change in characteristic impedance caused by the electrostatic bond in the case where the line is disposed within a housing is a decrease of 50% or more, signal degradation caused by mismatched impedances can be sufficiently reduced.

Through this, the characteristic impedance can be corrected without changing the line width of the flexible cable, thus making it possible to correct the impedance with the electric resistance values of the respective conductive lines set to essentially the same value. Furthermore, fluctuations in the characteristic impedance of the signal transmission line can be suppressed, and it is thus possible to suppress degradation in transmitted signals and transmit the signals in a stable manner.

Accordingly, a margin from the specified mask in the eye pattern can be increased. Meanwhile, although the dielectric sheet 1801 is wrapped around the region 312 in a part of the signal transmission line in a flexible cable, the present invention is not limited to a flexible cable, and the same effects can be achieved even in a wiring material or the like that uses conductor lines.

Although a method for correcting the characteristic impedance that changes when a housing, a conductor, or the like has come close has been described, it should be noted that the method for correcting the characteristic impedance is not limited thereto. For example, the same effects can be achieved even if the dielectric thickness, the conductor thickness, the distance between signal lines, and the disposition of the GND surface are changed from region to region in the signal transmission line.

Furthermore, the present invention can be applied in a signal transmission line for differential signals, such as LVDS (Low-Voltage Differential Signaling). Furthermore, although descriptions have been given regarding a coplanar structure flexible cable, for which the effects are the most pronounced, the characteristic impedance also fluctuates in the case where a GND surface is disposed on the upper end of a microstrip line, and thus the present invention can be applied therein as well. In such a case, the correction may be carried out by calculating an approximate value of the characteristic impedance by handling only the area of the microstrip line close to the housing as a pseudo strip line.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-256545, filed on Nov. 9, 2009 which is hereby incorporated by reference herein in its entirety.

What is claimed is:

1. A signal transmission line in which a signal line and a GND, both configured of a conductor foil, are formed within a dielectric, the signal transmission line being influenced by an electrostatic bond in the case where the signal transmission line has been disposed in a housing,
wherein the shape of the conductor foil is configured so that a margin from a predetermined mask in an eye pattern in the case where the signal transmission line is disposed in the housing is greater than a margin of a signal transmission line in which the shape of the conductor foil is configured so as to be constant between a transmitting end and a receiving end of the signal transmission line.

2. The signal transmission line according to claim 1, wherein the shape of the conductor foil is configured so as to cause a characteristic impedance to change in a partial region of the signal transmission line.

3. The signal transmission line according to claim 2, wherein the partial region of the signal transmission line is a region determined by the strength of an electrostatic bond with the GND or the conductor of the signal transmission line.

4. The signal transmission line according to claim 1, wherein the shape of the conductor foil is configured so as to cause the characteristic impedance to change by changing the conductor width in the signal transmission line configured of a flat wiring material.

5. The signal transmission line according to claim 4, wherein the distance between sections of the flat wiring material changes in accordance with movement of a device having a wound structure.

6. The signal transmission line according to claim 4, wherein the characteristic impedance in a first region of the flat wiring material whose characteristic impedance changes in accordance with movement of a device having a wound structure increases in accordance with the movement of the device more than the characteristic impedance in a second region that is adjacent to the first region.

7. The signal transmission line according to claim 1, wherein the margin from the predetermined mask in the eye pattern is a margin of the timing or the voltage of a signal waveform.

8. A signal transmission line in which a signal line and a GND, both configured of a conductor foil, are formed within a dielectric, the signal transmission line being influenced by an electrostatic bond in the case where the signal transmission line has been disposed in a housing,
wherein the distance between the conductor foils is configured so that a margin from a predetermined mask in an eye pattern in the case where the conductor foil is disposed in the housing is greater than a margin of a signal transmission line in which the distance between the conductor foils is configured so as to be constant between a transmitting end and a receiving end of the signal transmission line.

9. A signal transmission line in which a signal line and a GND, both configured of a conductor foil, are formed within a dielectric, the signal transmission line being influenced by an electrostatic bond in the case where the signal transmission line has been disposed in a housing,
wherein the dielectric constant of the conductor foil is configured so that a margin from a predetermined mask in an eye pattern in the case where the conductor foil is disposed in the housing is greater than a margin of a signal transmission line in which the dielectric constant of the conductor foil is configured so as to be constant between a transmitting end and a receiving end of the signal transmission line.

10. A signal transmission line in which a signal line and a GND, both configured of a conductor foil, are formed within a dielectric, the signal transmission line being influenced by an electrostatic bond in the case where the signal transmission line has been disposed in a housing,
wherein the thickness of the conductor foil is configured so that a margin from a predetermined mask in an eye pattern in the case where the conductor foil is disposed in the housing is greater than a margin of a signal transmission line in which the thickness of the conductor foil is configured so as to be constant between a transmitting end and a receiving end of the signal transmission line.
